(19) United States
(12) Patent Application Publication
(10) Pub. No.: US 2012/0311793 A1
(43) Pub. Date: Dec. 13, 2012

(54) MULTI-PURPOSE TOOL

(75) Inventors: George L. Oikarinen, Calumet, MI (US); Scott F. Zenner, Houghton, MI (US)

(73) Assignee: G & S Tool Company LLC, Calumet, MI (US)

(21) Appl. No.: 13/489,900

(22) Filed: Jun. 6, 2012

Related U.S. Application Data
(60) Provisional application No. 61/494,220, filed on Jun. 7, 2011.

(51) Int. Cl. B25F 1/00

(52) U.S. Cl. 7/167

(57) ABSTRACT

In one form, a tool may include a handle, a head and a connection feature. The head may have a planar lower surface and at least one side face inclined at an acute included angle relative to the lower surface. The connection feature interconnects the handle and head and may permit rotation of the head through any angle relative to the handle. The connection feature may also permit the head to be releasably secured in any desired angle or orientation relative to the handle.

### REFERENCE TO COPENDING APPLICATION

This application claims the benefit of U.S. Provisional Patent Application Ser. No. 61/494,220 filed Jun. 7, 2011, which is incorporated herein by reference in its entirety

### TECHNICAL FIELD

The present disclosure relates generally to a tool and more particularly to an implement or tool for scraping and other tasks.

### BACKGROUND

Carpets may be held down with tack strips which are themselves nailed to a floor or sub-floor covered by the carpet. When the carpet is removed, the tack strips remain in place and their removal can be a difficult, labor intensive task that takes significant time. Typically, not only must the strips themselves be completely removed, but the nails used to secure the strips to the floor must be dealt with to provide a surface upon which a new floor covering can be provided. Beyond tack strips, floors and other surfaces may require removal of debris, nails, glue, or anything else. For example, it may be desirable to break-up and remove tiles on a floor or wall, linoleum flooring, glue or other adhesives on a floor or wall, or the like. Or ice from walkways and other surfaces, and paving material from roads, driveways or walkways. Likewise, roofing materials like shingles, sheets and sealants may need to be removed prior to installation of new roofing materials. Individually and manually removing such debris or items can be time consuming and difficult. Beyond scraping, oftentimes tamping or flattening a surface is desirable either separately or in combination with some scraping.

### SUMMARY

In one implementation, a tool includes a handle, a head having a planar lower surface and at least one side face inclined at an acute included angle relative to the lower surface and a connection feature. The connection feature interconnects the handle and head and permits rotation of the head through any angle relative to the handle and releasably secures the head in any desired angle relative to the handle.

In at least some implementations, a tool may include a handle, a head and a connection feature. The handle may have at least a portion that is hollow and an access opening communicating with the hollow portion. The head may include an edge extending completely around a lower perimeter of the head, a planar lower surface adapted to be moved along a surface, an upper surface opposite the lower surface, and an aperture extending through the upper surface to facilitate connecting the handle to the head. The connection feature is connected to one end of the handle and has a lower surface adapted to be received adjacent to the upper surface of the head. The connection feature may further include a connector that connects together the connection feature and the head and releasably secures the connection feature to the head in any desired position of the head, and wherein material may be added to the hollow portion of the handle to adjust the weight of the tool.

A tool may include a handle, a head having an edge extending completely around a lower perimeter of the head, a planar lower surface adapted to be moved along a surface, an upper surface with a circular recess formed in the upper surface, and an aperture extending into the recess to facilitate connecting the handle to the head. A connection feature connected to one end of the handle has a lower surface adapted to be received within the recess so that the connection feature can be rotated relative to the head through any angle, the connection feature including a connector that connects together the connection feature and the head and releasably secures the connection feature to the head in any desired position of the head.

### BRIEF DESCRIPTION OF THE DRAWINGS

The following detailed description of preferred embodiments and best mode will be set forth with reference to the accompanying drawings, in which:

FIG. 1 is a top view of a tool, with a holding feature shown exploded from the assembled tool;

FIG. 2 is side view of the tool in FIG. 1;

FIG. 3 is top view of the tool in FIG. 1 with an extension shown in a first position; and

FIG. 4 is top view of the tool in FIG. 1 with an extension shown in a second position.

### DETAILED DESCRIPTION OF PREFERRED EMBODIMENTS

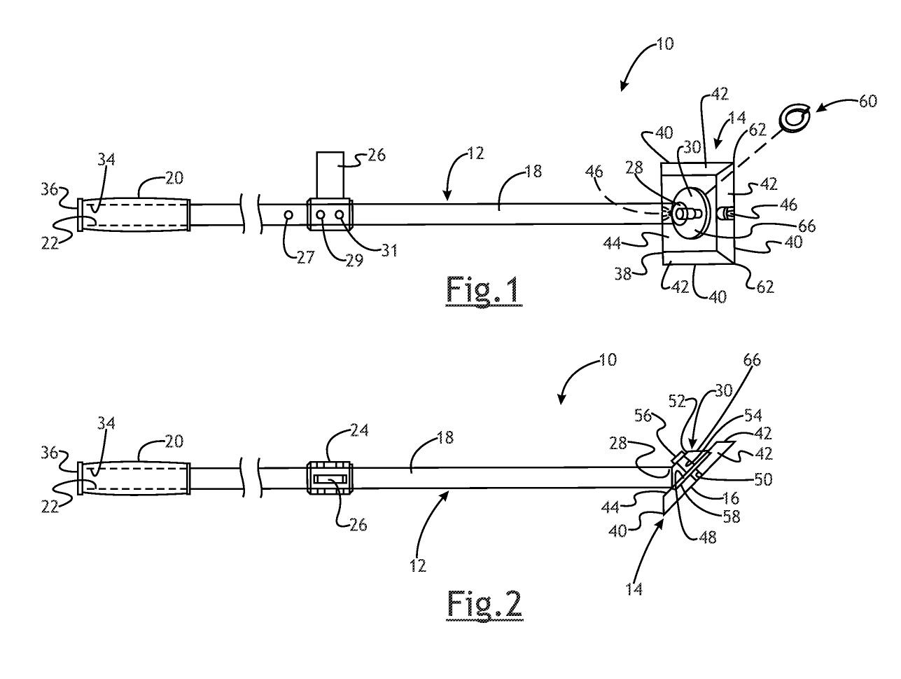

Referring now to FIGS. 1 through 4, in which like numerals indicate like parts, a multi-purpose tool 10 is shown. The tool 10 may include a handle 12 and a head 14. The handle 12 may be elongated so a user can grasp the handle 12 while standing, if desired. The head 14 may have a planar lower surface 16 adapted to be slid along or across a generally planar surface, like a floor or wall. In one use of the tool, a user may grasp the handle 12 and slide the head 14 along a surface to easily scrape away nail heads and the other debris or things from the surface with relatively little effort.

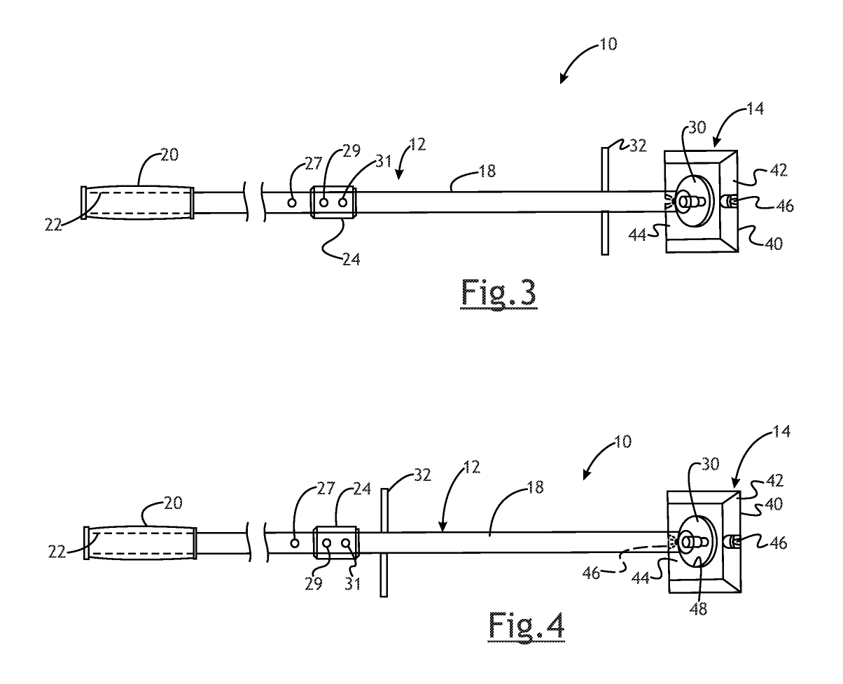

The handle 12 may include a shaft 18 and a grip 20 on a first end 22 of the shaft 18, wherein the grip 20 may be grasped by a hand of the user. Another handle feature 24 may be provided spaced from the first end 22 of the shaft. The handle feature 24 may be movable along the shaft 18, or it may be stationary. And the handle feature 24 may be movable amongst multiple positions, and may be releasably retained in each position, such as by a detent mechanism or a locking/set screw that bears against the handle. The handle feature 24 may include a projecting member 26 that extends outwardly from the shaft 18. The projecting member 26 may be acted upon (e.g. pushed or kicked) by a foot of a user, such as when the handle feature 24 is positioned sufficiently near the head 14, or pushed or hit by a hand of the user when the handle feature 24 is positioned sufficiently near the grip 20. In the implementation shown, the handle includes one or more openings 27, which may be threaded, and the handle feature 24 may include a screw 29 adapted to be received in one of the openings 27, and a locking screw 31 adapted to engage and be tightened against the handle to retain the position of the handle feature 24 along the shaft. The handle feature 24 could also be retained by only the locking screw 31 at other positions along the shaft 18, and the handle feature can be rotated about the shaft to position the projecting member 26 in any desired orientation when the screw 29 is removed from an opening 27. The handle feature 24 may include a plastic or metal tubular sleeve disposed on the shaft and to which the projecting member 26 is attached, such as by a weld, bracket, screws, bolts, etc. The locking screw 31 may be received through a threaded opening in the sleeve and may extend fully through the sleeve so that the end of the locking screw may bear on the shaft 18. In an implementation where the projecting member is not included (e.g. as shown in FIGS. 3 and 4), the handle feature 24 may act as a second hand grip.

A second end 28 of the handle 18 may be connected to the head 14. The handle 12 may include a threaded second end 28 or may be connected, such as by a weld, adhesive, press fit, detent or latch, mating tapered walls, or other method, to the head 14 itself or to an adapter or connection feature 30 or other component which may be threaded or otherwise designed to facilitate releasable connection of the handle 12 to the head 14. Of course, the handle 12 could also be permanently connected to the head 14 such as by a weld, or releasably connected to the head 14 in some other manner than mating threads, for example, by spring loaded detents, hook or latch, etc.

The shaft 18 could be formed from an at least partially tubular piece of metal, or it could be a solid metal or wooden pole. The shaft 18 may be between about 2 feet and 6 feet in length, and it may be extendable/retractable, or of a fixed length. As shown in FIGS. 3 and 4, the handle 12 may optionally include an extension 32 that extends outwardly from the shaft 18. The extension 32 may be fixed to the shaft 18, it may be removable and positioned in different locations along the shaft, and/or more than one extension may be provided. Such an extension 32 may comprise a dowel or rod that may have threads received in a threaded opening in the shaft, or the rod 32 may be held on the shaft 18 by one or more cotter pins or other known connector(s). As shown in FIG. 3, the extension 32 may be located adjacent to the head 14 and may be acted upon by, for example, a foot of the user to enable extra force to be applied to the tool 10. As shown in FIG. 4, the extension 32 may be located closer to the grip 20 or first end 22 of the shaft 18 to permit one or both hands of the user to grasp the extension and apply force to the extension via the user's hands and arms. The extension 32 may be cantilevered from one side of the shaft, or the extension may extend through the shaft and out each side of the shaft in generally a t-shape, as shown in FIGS. 3 and 4. The extension 32 may be used in place of the handle feature 24 and projecting member 26, or in combination with these components, as desired.

In implementations where the shaft 18 is at least partially tubular and hollow, the shaft may include an access opening 34 through which matter may be added to the hollow portion of the shaft to increase the weight of the tool 10, if desired. The matter may include granular materials like sand or rocks, liquids like water, solids like a metal pole insert, or a flowable material that becomes solid like concrete. In general, any suitable material may be provided into the shaft 18, as desired. The access opening 34 may be provided anywhere along the shaft, or it may be defined by one end of the shaft and may be covered by the grip or extend through the grip when the grip is installed on the handle, as shown in FIGS. 1 and 2. A plug or cover 36 may be provided to close the access opening 34, and the plug or cover may be defined on or by the grip 20, may be carried by the grip, or it may be a separate piece from the grip. In one form, the grip 20 may be removed to permit material to be added into the shaft 18 via the first end 22 of the shaft, and then the grip may be placed onto the shaft to cover the first end and maintain the material within the shaft.

The head 14 may include a main body 38 that may have a peripheral edge 40 about a lower perimeter of the body 38 and a planar lower surface 16. To define a sharper edge, side faces 42 of the main body 38 may extend at an acute included angle from the lower surface 16 to an upper surface 44 of the head 14. In the implementation shown, the head 14 has four side faces 42 inclined at an acute included angle relative to the lower surface 16 to define a truncated pyramid shaped head with an upper surface 44 of lesser surface area than the lower surface 16, and side faces 42 that may be at least one-quarter inch in length between the lower surface and upper surface. In one implementation, the lower surface 16 may be about 2 to 8 inches or more on a side or otherwise have a surface area of about 4 inches square to 80 inches square and the side faces 42 may have a height of between about ¼ to 5 inches. The head 14 could have any desired size or shape, providing any number of faces 42 (including one or more than one face) which may be linear, arcuate or otherwise arranged. The lower surface 16 may be polygonal in shape, such as a square, rectangle, triangle, star (with any number of points), pentagon, hexagon, octagon, etc. The heads 14 may be interchangeable so that a handle 12 can be used with several different heads, if desired. In a presently preferred form, the head 14 may be formed from a hardened steel material and may weigh between 0.5 and 20 pounds. Of course, other weights are possible.

One or more of the side faces 42 may include one or more notch(es) 46 or slot(s) in which an object may be received to facilitate removal of at least a portion of the object from a surface. Representative objects may include, without limitation, the shank of a nail or the leg (or legs) of a staple. Of course, other things may be received in the notch(es) 46, as desired, and the notch(es) may be of any shape and size, and a head 14 could include multiple notches that are of different or the same shape and size, as desired. The notch(es) 46 may facilitate prying such an object from a surface or shearing off the portion of the object extending outwardly from the surface. A recess 48 may be provided in the upper surface 44 to at least partially receive the connection feature 30 coupling the handle 12 to the head 14. The recess 48 may be centered on the upper surface 44 of the head 14, and in one implementation, the recess is circular although other shapes may be used. An aperture 50 (FIG. 2) may be formed in the head 14, and the aperture may extend through the head from the lower surface 16 to the upper surface 44, although that is not required. The aperture 50 may be threaded and may be provided within the recess 48, such as within the center of the recess and hence, the center of the head 14.

The adapter or connection feature 30 may consist of a body 52 having one or more apertures 54 therethrough. The connection feature 30 may include a connector that couples the body 52 to the head 14. The connector may be a bolt 56 that may have a threaded shank that extends through the aperture 54 in the connection feature 30 and into the aperture 50 in the head 14 which may be threaded to receive and retain the bolt. The bolt 56 will retain the connection feature 30 on the head 14. The main body 52 of the connection feature 30 may have a planar lower surface 58 adapted to be received within the recess 48 in the head 14. The periphery of the lower surface 58 may be complementary to the shape of the recess 48, and is shown here as being circular. Of course, other shapes could be used and the lower surface 58 need not be complementary in shape to the recess 48. A holding feature 60 may be provided to maintain a desired angular position of the head 14 relative to the shaft 18, and to ensure a tight connection between the head 14 and connection feature 30 that inhibits becoming loose in use. The holding feature may include a lock washer 60 or other component received between the lower surface 58 of the main body 52 and the lower surface of the recess 48. When the bolt 56 is tightened, the lock washer 60 may be compressed between the main body 52 and head 14 and provide a frictional retention between the main body and head. Upon loosening the bolt 56, the head 14 may be rotated relative to the main body 52 and shaft 18.

The connection feature 30 may be removable received in the recess 48 and/or adjustable relative to the recess to permit the angular position of the connection feature to be changed, as desired. This may permit the head 14 to be rotated relative to the handle 12. At least in the implementation where the recess 48 is circular, the connection feature 30 may be rotated through any angle (i.e. 360 degrees of rotation) desired to position the head 14 as desired relative to the shaft 12. This may position any one of the edges, or any portion of the edge 40, of the head 14 facing forward and generally perpendicular to an intended path of travel of the head in use, or at any other angle relative to the intended path of travel including an angle where a corner 62 (FIG. 1) between two edge portions 40 of the head 14 is oriented in line with the path of travel. Desirably, if one edge portion 40 becomes worn, any other edge or edge portion can be rotated into position for use. Of course, the path of travel may vary and the tool 10 may be used in a sideways motion, a circular motion, or in any other manner in addition to a forward/backward path. The tool 10 may also be used to tamp down, pound or flatten objects or surfaces, such as by raising the head 14 and then lowering it and causing the lower surface 16 to strike the object or surface. This may facilitate packing and flattening an outdoor ground surface, setting/driving a nail or staple flush into a surface, etc.

The main body 52 of the connection feature 30 may include a side surface 66 adapted to be connected to the shaft 18. One or both of the side surface 66 and the second end 28 of the shaft 18 may be inclined or beveled so that the shaft 18 extends from the connection feature 30 at a desired angle relative to the lower surface 16 of the head 14. In at least some implementations, the angle may be between 30 and 60 degrees, with one of the many possibilities being about 45 degrees. The shaft 18 may coupled to the connection feature 30 in any suitable way, for example without limitation, by welding, a bolt or via a threaded adapter interconnecting these two components.

In the form shown, the connection feature 30 may itself define a secondary tool. The main body 52 may have a relatively sharp edge defined between the side surface(s) 66 and the perimeter of its lower surface 58, and that edge and the planar lower surface 58 may be used in a manner similar to the main tool 10 and head 14. The smaller main body 52 of the connection feature 30 may facilitate scraping or otherwise using the secondary tool in a smaller or confined space, when the connection feature 30 is removed from the head 14. The main body 52 may be made from a hardened metal material, or any other suitable material.

It will be understood that each of the elements described above, or two or more together, may also find a useful application in other types of constructions differing from the types described above. The various features may be employed independently or in any suitable combination.

Further, the various embodiments of a tool disclosed herein, that has many uses such as removing nail heads and other debris from a surface, demolition tasks, tamping, etc., are not limited to the details shown, since it will be understood that various omissions, modifications, substitutions and changes in the forms and details of the devices illustrated and their operation can be made by those skilled in the art without departing in any way from the spirit and scope of the present disclosure.

1. A tool, comprising:
a handle;
a head having a planar lower surface and at least one side face inclined at an acute included angle relative to the lower surface; and
a connection feature interconnecting the handle and head and permitting rotation of the head through any angle relative to the handle and releasably securing the head in any desired angle relative to the handle.

2. The tool of claim 1, wherein said at least one side face defines an edge extending completely around a lower perimeter of the head.

3. The tool of claim 2, wherein said at least one side face includes a plurality of side faces each inclined at an acute included angle relative to the lower surface.

4. The tool of claim 1, wherein at least a portion of the handle is hollow and an access opening communicates with the hollow portion to permit material to be added into the hollow portion of the handle.

5. The tool of claim 1, which also comprises an extension carried by the handle and projecting outwardly from the handle, wherein a force applied to the extension is transmitted to the head through the handle.

6. The tool of claim 1 which also includes a holding feature that retains the angular orientation of the head relative to the connection feature.

7. The tool of claim 1 wherein the handle includes a shaft, a grip at one end of the shaft, and another handle feature spaced from grip and movable along the shaft and relative to the grip.

8. The tool of claim 7 wherein the handle feature includes a projecting member that extends outwardly from the shaft so that the projecting member is adapted to be acted upon by a user of the tool.

9. The tool of claim 7 wherein the handle feature is moveable along the shaft between a position adjacent to the head and a position adjacent to the grip.

10. The tool of claim 9 wherein the handle feature is releasably retained in said positions along the handle.

11. A tool, comprising:
a handle having at least a portion that is hollow and an access opening communicating with the hollow portion;
a head, having:
an edge extending completely around a lower perimeter of the head,
a planar lower surface adapted to be moved along a surface, and
an upper surface opposite the lower surface, and
an aperture extending through the upper surface to facilitate connecting the handle to the head; and
a connection feature connected to one end of the handle and having a lower surface adapted to be received adjacent to the upper surface of the head, the connection feature including a connector that connects together the connection feature and the head and releasably secures the connection feature to the head in any desired position of the head, and wherein material may be added to the hollow portion of the handle to adjust the weight of the tool.

12. The tool of claim 11 wherein the handle includes a shaft, a grip at one end of the shaft, and another handle feature spaced from grip and movable along the shaft and relative to the grip.

13. The tool of claim 11 wherein the handle feature is moveable along the shaft between a position adjacent to the head and a position adjacent to the grip.

14. The tool of claim 13 wherein the handle feature is releasably retained in said positions along the handle.

15. A tool, comprising:
a handle;
a head, having:
an edge extending completely around a lower perimeter of the head,
a planar lower surface adapted to be moved along a surface, and
an upper surface with a circular recess formed in the upper surface, and
an aperture extending into the recess to facilitate connecting the handle to the head; and
a connection feature connected to one end of the handle and having a lower surface adapted to be received within the recess so that the connection feature can be rotated relative to the head through any angle, the connection feature including a connector that connects together the connection feature and the head and releasably secures the connection feature to the head in any desired position of the head.
